(19) United States
(12) Patent Application Publication
(10) Pub. No.: US 2014/0229139 A1
(43) Pub. Date: Aug. 14, 2014

(54) METHOD AND DEVICE FOR DETERMINING THE VELOCITY OF AN AIRCRAFT

(71) Applicant: Airbus Operations GmbH, Hamburg (DE)

(72) Inventors: Matthias HEGENBART, Ahlerstedt (DE); Nabankele-Martial SOMDA, Hamburg (DE)

(21) Appl. No.: 14/174,336

(22) Filed: Feb. 6, 2014

Related U.S. Application Data
(60) Provisional application No. 61/763,489, filed on Feb. 12, 2013.

(30) Foreign Application Priority Data
Feb. 12, 2013 (DE) 102013101351.1

(51) Int. Cl. G01P 5/00

(52) U.S. Cl. CPC G01P 5/001
USPC 702/144

(57) ABSTRACT

A method for determining the flight velocity of an aircraft comprising a flow body is provided. The method comprises acquiring a change in length of a structural component connected to the flow body; determining at least one aerodynamic force acting on the flow body based on the acquired change in length of the structural component connected to the flow body; determining a flow coefficient of the flow body; and calculating the incident flow velocity on the flow body, taking into account the determined flow coefficient and the determined aerodynamic force. With this method reliable determination of the flight velocity can take place without measuring the dynamic pressure.

### CROSS-REFERENCE TO RELATED APPLICATIONS

This application claims priority to German Patent Application No. 10 2013 101 351.1, filed Feb. 12, 2013, and to U.S. Provisional Patent Application No. 61/763,489, filed Feb. 12, 2013, which are each incorporated herein by reference in their entirety.

### TECHNICAL FIELD

The technical field relates to a method and a device for determining the velocity of an aircraft and to an aircraft with a device for determining the velocity of the aircraft.

### BACKGROUND

In the state of the art, determining the velocity of an aircraft relative to the incident airflow around it usually takes place by way of measuring the dynamic pressure caused by the air with the use of a pitot tube or a Prandtl sensor. From a knowledge of the density p of the air, which can be determined by way of a thermal equation of state in relation to the flight altitude and the ambient temperature present at that location, the speed relative to the air can be calculated. This speed is referred to as “true air speed” (TAS).

For reasons of redundancy several pitot tubes or Prandtl sensors can be used which make it possible to independently determine the velocity. Because of the exposed position of pitot tubes on the external skin of the aircraft and because of the opening facing in the direction of flight, when the aircraft is on the ground pitot tubes are covered by a protective cap, and when the aircraft is in flight are heated to safeguard against ice buildup.

DE 10 2010 019 811 A1 and WO 2011/138437 A1 disclose a method and a device for measuring the flow velocity of air with the use of a laser beam pulse focused in the airflow, which pulse in the beam focus results in the formation of plasma, and the acoustic and/or optical effects that occur during plasma formation are acquired and from them the flow velocity of the air is determined

In addition, other objects, desirable features and characteristics will become apparent from the subsequent summary and detailed description, and the appended claims, taken in conjunction with the accompanying drawings and this background.

### SUMMARY

It may be advantageous, among other things, to achieve a determination of the flight velocity independently of measuring the dynamic pressure in order to increase redundancy. According to the various teachings of the present disclosure, provided is as robust a method as possible and a simple, reliable and lightweight device for determining the flight velocity of an aircraft independently of directly measuring the dynamic pressure.

In one embodiment, proposed is a method for determining the flight velocity of an aircraft comprising a flow body, comprising the following: acquiring a change in length of a structural component connected to the flow body; determining at least one aerodynamic force acting on the flow body based on the acquired change in length of the structural component; determining a flow coefficient of the flow body; and calculating an incident flow velocity on the flow body, taking into account the determined flow coefficient and the determined aerodynamic force.

When the aircraft is in flight, essentially in all regions of the surface of the aircraft that are subjected to incident flow, forces occur that depend on the flight velocity of, and the incident flow to, the aircraft. It is the objective, from a force acting on the structure of the aircraft and resulting from the incident flow around a flow body, to determine an underlying aerodynamic force in a predetermined direction of action. The aerodynamic force acting on the flow body results from the shape of the flow body, from the resulting various aerodynamic flow coefficients, and from the incident flow velocity or the dynamic pressure present on the flow body. By determining the aerodynamic force on the flow body the incident flow velocity and thus the flight velocity can be calculated. It is useful, in the context of the method according to the present disclosure to investigate a flow body already present on the aircraft, which flow body has a known aerodynamic behavior, so that relevant flow coefficients of the flow body are already known or are easily determinable. Of course, the method may also be carried out by means of several mutually independent flow bodies, wherein the method may then, for example, be carried out in parallel, sequentially, independently and multiply simultaneously.

The flow body could comprise a wing and a tail unit, for example a horizontal stabilizer unit, or a vertical stabilizer unit, which tail unit is in each case mechanically connected to the structure of the aircraft. The force transmitted to the structure results in elongation of the affected structural components, which elongation can be measured with the use of various methods as a relative change in length. By acquiring a change in length of a structural component connected to the flow body, consequently conclusions relating to an aerodynamic force acting on the flow body can be drawn, which force is significantly responsible for the acquired change in length.

The structural component on which the change in length is acquired may be a flange, a brace, a stiffening member or some other components which generally, but not necessarily, are directly subjected to a force by the flow body. While tail units are often connected to a structure by way of flanges, wings of a larger commercial aircraft are normally connected to the fuselage structure by way of a so-called wing box. In the case of mechanically simple load paths, in the integration of the method according to the present disclosure, by analytical determination of the flux of force from the flow body to the structure, it is possible to determine the relationship between a change in length that may be acquired on the structure, or the force resulting in said change of length, and the aerodynamic force to be determined In a simple case such determination may take place according to the general principles of engineering mechanics for calculating static forces. In more complex load paths between the flow body and the structure, for example in the case of the wing box, the relationship between the aerodynamic force and the change in length that may be acquired in the particular direction, or the force resulting in such change in length, may be determined by way of numeric or experimental investigations. It is imaginable, at least in the latter case, by way of a one-dimensional or multi-dimensional data set with interpolable data points to provide an easy-to-use evaluation table.

Determining at least one flow coefficient may, in one example, comprise determining a drag coefficient (c_{w}) and a lift coefficient (cₐ). Such flow coefficients are commonly used for determining, in particular, aerodynamic drag in all types of vehicle; they are based on a Bernoulli equation adapted to practical use. Said equation states that a force acting on the flow body in a direction x expresses itself as Fₓ=cₓ·ρ/2·v²·A, where cₓ denotes the flow coefficient relating to the force in x-direction, v denotes the flow velocity, and A denotes the surface area of a surface that is subjected to the flow and that is effective in a relevant manner for the force acting in the x-direction. The flow coefficient cₓ may be a drag coefficient c_{w}, a lift coefficient cₐ or some other suitable parameter. With a knowledge of the aerodynamic force in the x-direction and a knowledge of the coefficient cₓ, it is possible to calculate the velocity v.

As has been mentioned previously, generally a flow body is to be investigated that comprises a known aerodynamic behavior. Accordingly, a flow coefficient of the flow body, which flow coefficient is responsible for drag in the direction of flight, may, for example, be known from wind tunnel experiments, and consequently, if a force is known, with the use of a flow coefficient that has been determined metrologically, easy determination of the flow velocity is possible.

The method according to the present disclosure provides a particular advantage in that determining the flow velocity and thus the flight velocity is completely independent of environmental conditions. Furthermore, in contrast to methods using Prandtl sensors, the use of the method according to the present disclosure does not require a measuring device whose protective cap needs to be removed, nor does it require heating. Because the method according to the present disclosure is based on a measuring method that differs completely from dynamic-pressure measuring, it is eminently suited to supporting values relating to the flow velocity, which values have been obtained with the use of classical methods.

Modern aircraft may be equipped with a so-called structural health monitoring system (SHM-system) that at several locations within the aircraft continuously measures local elongation, and from this among other things determines the remaining service life of the associated component or the forces acting on the structure. It is imaginable to use data from this system in order to determine knowledge relating to changes in length or to forces acting on the structure, which changes in length result from aerodynamic forces. The method according to the present disclosure may thus be implemented practically without modifications on the component side by way of expansion of a computer program installed in an on-board computer, which computer program is, for example, responsible for the SHM-system.

In one embodiment the at least one aerodynamic force comprises the drag of the flow body. In this context the term drag refers to the force that acts against thrust. The drag, also referred to as F_{w}, thus acts in the negative x-direction of an aircraft-fixed coordinate system. Drag can generally be measured on a vertical stabilizer of the aircraft, because in straight flight with ideal conditions the vertical stabilizer is exclusively subjected to drag. Only in the case of crosswind or yaw is the vertical stabilizer also subjected to forces acting across the drag. In the simplest case it would thus be possible to measure in the longitudinal direction the force that acts on the structure of the aircraft, which force emanates from a vertical stabilizer, in order to indicate drag. It is also relatively easy to determine the relevant flow coefficient, which may very easily be read out with the use of experimentally determined data records.

The use of an aircraft-fixed coordinate system, for example according to DIN 9300, suggests itself when compared to the use of a flight-path-fixed or aerodynamic coordinate system, because the relationship between the structure and the aircraft-fixed coordinate system is always unequivocal.

In one embodiment the at least one aerodynamic force comprises the lift of the flow body. The flow body may be designed as a horizontal stabilizer unit or as a wing that practically under all flight conditions causes a lift Fₐ extending across the drag, which lift acts on the structure that incorporates the flow body. Determining the flow coefficient may vary greatly, depending on the angle of attack α on the flow body.

In one exemplary embodiment, determining the flow coefficient may comprise reading out the flow coefficient based on a measured or set angle of attack from a data record. In commercial aircraft currently in widespread use the angle of attack may be acquired by a corresponding sensor and may be stored by a central calculation unit of the aircraft, for example an air data system. After the angle of attack has been called up, a flow coefficient may be read from a data record, and ideally from a flow-coefficient gradient data record, and thereafter the velocity may be determined The angle of attack on a flow body may differ from the angle of attack on a wing. If the flow body is a horizontal stabilizer unit, its incident airflow depends largely on the incident airflow around the wing, and consequently when the angle of attack of the flow around the wing is measured it would also be possible to derive the flow coefficient on a horizontal stabilizer unit, taking into account an individual setting angle of the horizontal stabilizer unit. In order to implement the method it is also possible to use information relating to an already set angle of attack from an on-board computer of the aircraft for the calculation of the flight velocity.

In one embodiment, determining the flow coefficient comprises determining a quotient from the lift and the drag, and determining the flow coefficient from a polar curve of the flow body. The term “polar curve” refers to a functional relationship between a lift coefficient, a drag coefficient and an angle of attack α. The polar curve may be illustrated in the form of a polar diagram, wherein the vertical axis shows the lift coefficient cₐ, and the horizontal axis shows the drag coefficient c_{w} . The distance from the origin of the polar diagram to each point of the polar diagram is marked by the height of the quotient cₐ/c_{w} present at that location. If the value of this quotient is known, graphically with reference to the polar diagram, analytically by taking into account a functional relationship, or by reading out a tabular data record, if necessary with interpolation, the associated point on the polar curve may easily be determined and on said polar diagram both the flow coefficient cₐ and the flow coefficient c_{w} may be determined The aforementioned quotient of the flow coefficients, which quotient is also referred to as “k”, furthermore corresponds to the quotient of lift and drag Fₐ/F_{w}. Simultaneous measuring of lift and drag on the flow body thus makes it possible to determine k, and consequently from this the desired flow coefficients may be directly determined from the polar curve. Subsequently, either based on cₐ and Fₐ or based on c_{w} and F_{w} the flow velocity v may be calculated.

In one exemplary embodiment, determining the at least one aerodynamic force acting on the flow body comprises calculating a force that causes the acquired change in length in the structural component taking into account its materials characteristics, and comprises determining the at least one aerodynamic force as an effective force component in a predetermined direction of the aircraft. By measuring the elongation it is possible, without any modification of the underlying structure, to derive the force that causes said elongation, which force in turn depends on the aerodynamic force acting on the flow body. Apart from a functional relationship between the change in length and the aerodynamic force it is possible to directly determine the force acting on the structural component to be taken into account, in order to, from it, determine the aerodynamic force. Since in an aircraft there are often branched structures and multiple load paths for the connection of flow bodies, this is to be taken account in determining the underlying force. In a framework, based on the measured bar force of an individual bar of the framework, by means of prior analytical determination of the force component borne, it is possible without further ado to derive the corresponding force acting on the flow body. As mentioned above, in this context, too, transformation in a direction of incident flow is advantageous in terms of the accuracy of the result. In a particularly advantageous manner the elongation or force acting on a structural component, which elongation or force has already been determined by an SHM system, may be used to determine the flight velocity.

If the flow body is mounted with the use of several independent flanges, it is of course also possible to determine the overall force acting on the flow bodies by means of adding several determined partial forces acting on each flange.

Measuring the change in length may take place by means of at least one strain gauge or by means of optical methods, for example by means of fiber Bragg gratings. Inserting a strain gauge results in particularly weight-saving but nevertheless very reliable and accurate measuring of the elongation. The above-mentioned optical method may, furthermore, render particularly small elongations precisely acquirable.

In one embodiment, a device for determining the flight velocity of an aircraft comprising a flow body is provided. The device further comprises a device for acquiring a change in length of a structural component connected to the flow body and a calculation unit that is configured to determine at least one aerodynamic force acting on the flow body based on the acquired change in length; to determine a flow coefficient of the flow body; and to calculate an incident flow velocity on the flow body based on the flow coefficient and on the aerodynamic force. This device may also be designed in multiple parts, wherein, for example, the calculation unit in the form of an algorithm may be integrated in an already existing device. In an aircraft, an on-board computer may suggest itself for this purpose, which computer comprises, for example, the air data system, a flight management system or other devices. Determining the aerodynamic force may be carried out directly with reference to the change in length, for example by an experimentally-determined relationship that is present in the form of a data record, or by means of prior calculation of the force causing the change in length.

It is advantageous that the device for acquiring the change in length furthermore comprises at least one strain gauge and/or an optical device for acquiring a change in length, which may be connected to the device by way of a corresponding interface, a transducer or some other devices. The device for acquiring the change in length is arranged at or on the corresponding structural component.

Furthermore, it is preferred for carrying out determination of the flight velocity to provide a storage device that is connectable to the calculation unit, which storage device is configured to provide aerodynamic and/or mechanical parameters to the calculation unit. These parameters may contain materials characteristics, aerodynamic coefficients and other key indicators by means of which from the acquired change in length the force acting on the structural component or the underlying aerodynamic force may be calculated. The storage device may be integrated in the calculation unit or it may be designed as an external component and may store parameters by way of a one-dimensional or multi-dimensional data record, and may provide said parameters on request.

Furthermore, the present disclosure relates to an aircraft comprising at least one flow body and a device for determining the flight velocity. In one embodiment the flow body is a vertical stabilizer. In one embodiment the flow body is a horizontal stabilizer. Likewise, in one embodiment, the flow body can be a wing of the aircraft.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a lateral view of an aircraft according to an exemplary embodiment.

FIG. 2 shows a top view of an aircraft according to an exemplary embodiment.

FIG. 3 shows a polar diagram.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

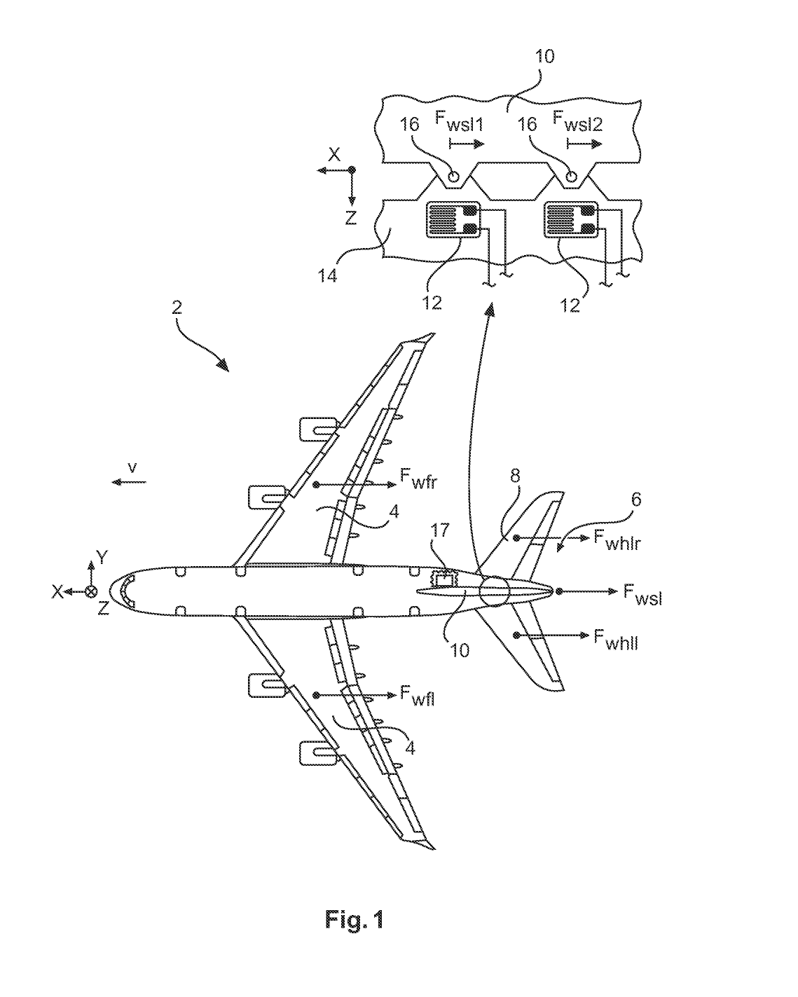

FIG. 1 shows an aircraft 2 comprising two wing halves 4 and a tail unit arrangement 6 with a horizontal stabilizer unit 8 and a vertical stabilizer unit 10. A longitudinal axis of the aircraft points in a direction designated “x”, and a direction that extends perpendicularly laterally to the aforesaid is designated “y” in an aircraft-fixed coordinate system. A z-axis extends into the drawing plane and is arranged perpendicularly both on the x-axis and on the y-axis.

During flight of the aircraft 2 in the x-direction an airstream over the wing halves 4 and over the tail unit arrangement 6 arises. Depending on the aerodynamic characteristics, during incident flow a lift Fₐ and a drag F_{w} result. In the case of the vertical stabilizer 10 as a result of the perpendicular arrangement relative to the direction of flight x this is not referred to as “lift”. For example, in FIG. 1 drag F_{wf} is denoted on the wing halves 4, and F_{whl} is denoted on the horizontal stabilizer unit 8. F_{wfr} more precisely refers to drag of the right-hand wing, while F_{wfl} refers to drag of the left-hand wing. Analogously to the above, F_{whlr} refers to drag of the right-hand horizontal stabilizer unit, while F_{whl1} refers to drag of the left-hand horizontal stabilizer unit. Finally, F_{wsl} refers to drag of the vertical stabilizer 10. The concrete drag depends on the measured velocity v and the relevant flow coefficient c_{w} . . . ; it is calculated as a product of the dynamic pressure q, the surface area A of the effective surface, and the flow coefficient c_{w} . . . . In this context the dynamic pressure q quadratically depends on the velocity v and singly depends on the air density. Thus with the knowledge of the drag of a flow body it is possible to determine the velocity v of the aircraft 2 if the relevant flow coefficient is also known.

In the case of a commercial aircraft which as a result of extensive experimental and theoretical investigations has clearly predictable aerodynamic characteristics, flow coefficients over all flight conditions are known. This means that for calculating the velocity ν, from a measured drag or a measured lift a flow coefficient of known data can be determined, and with it the velocity ν may be calculated.

Below, as an example, calculating the flow velocity with reference to acquiring a change in length of a vertical-stabilizer supporting structure is described. In symmetrical straight flight the drag coefficient c_{wsl} of the vertical stabilizer 10 is relatively constant over wide boundaries, so that from an experimentally determined value relating to the drag coefficient c_{wsl} by solving a transformed Bernoulli equation the velocity is determined according to the following simplified equation:

$$v = \sqrt{\frac{2 \cdot {F}_{wsl}}{ρ \cdot A \cdot {c}_{wsl}}} . \qquad ( 1 )$$

In determining this aerodynamic force acting on the flow body, which is designed as a vertical stabilizer 10, for example, as shown in the cutout of FIG. 1, strain gauges 12 may be used that acquire the deformation or the relative change in length of a structural component 14 that is connected to the flow body 10, for example by way of several bearing points 16. As a result of elongation-induced changes in the resistance, individual strain gauges make it possible to acquire local deformation of the structural component 14, and for this purpose said strain gauges are arranged directly on the bearing points 16. A calculation unit 17 is connected to the strain gauges 12 and is configured to carry out the method according to the various teachings of the present disclosure. To this effect the calculation unit 17 may comprise a storage unit or may be connected to an external storage unit that can, on request, provide the necessary aerodynamic parameters, for example drag coefficients, lift coefficients or k-factors, and mechanical parameters, for example materials characteristics of the structural component in question, or load factors as a ratio of the force causing the elongation, to the aerodynamic force. The calculation unit is, as an example, shown in the aft region of the aircraft 2, but this arrangement is not mandatory. The function of the calculation unit 17 may also be implemented by way of a suitable algorithm in already existing on-board computers of the aircraft 2. It is also imaginable for an electronics unit, for example an interface device or a transducer, to be arranged near the strain gauges 12 and to be able to communicate, by way or a bus or a network, with an on-board computer in an avionics compartment, which on-board computer is arranged in the nose region of the aircraft 2.

The force that acts from externally through the vertical stabilizer 10, which force is responsible for the deformation, may be determined in various ways. On the one hand it is possible to use a previously experimentally determined functional relationship between the relative change in length of the structural component 14 under investigation and the aerodynamic force to be determined, in order to from the acquired relative change in length to directly determine the aerodynamic force. On the other hand it would be possible, from the acquired relative change in length to also calculate the force acting on the structural component 14, from which force analytically the underlying aerodynamic force may be determined If, as is the case in the example shown, several bearing points 16 of a structural component 14 are subjected to the aerodynamic force, by means of the addition of the individual forces, which are, for example, designated F_{wsl1} and F_{wsl2}, the entire drag F_{wsl} of the vertical stabilizer 10 may be determined Furthermore, arranging the strain gauges should generally continue to take place in such a manner that the force is measured in the longitudinal direction, i.e. along the x-axis.

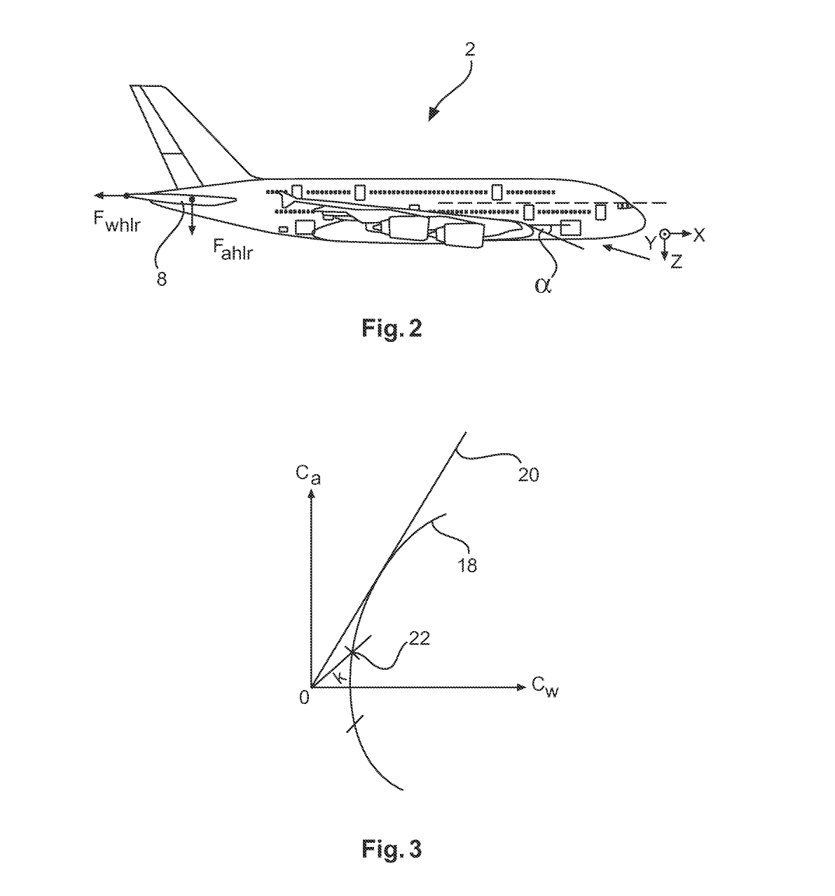

In the case of somewhat more complex aerodynamic characteristics, for example in the horizontal stabilizer unit 8, determining the flow coefficient may render it necessary to determine both the drag F_{whlr} and the corresponding lift Fₐₕₗᵣ, by means of which from known data the required flow coefficient may be determined. As an example, these two parameters are shown in FIG. 2. Below, the method is explained with reference to the right-hand half of the horizontal stabilizer unit 8.

The lift Fₐₕₗᵣ is directed in the z-direction because in the aircraft design shown the horizontal stabilizer unit 8 usually causes a downforce to make it possible to equalize the moment household on the pitch axis of the aircraft 2. After the two forces F_{whlr} and Fₐₕₗᵣ have been determined, the quotient of the two forces may be determined so that a value “k” results: k=Fₐₕₗᵣ/F_{whlr}. This value also corresponds to the quotient of lift coefficient cₐₕₗᵣ and drag coefficient c_{whlr: k=c}ₐₕₗᵣ/c_{whlr}. Since the lift coefficient and the drag coefficient are not completely independent of each other, when the quotient k is known, the exact lift coefficient or the drag coefficient can be determined, for example from the experimentally determined polar curve of the horizontal stabilizer unit 8, which defines a functional relationship of the lift coefficient cₐₕₗᵣ, of the drag coefficient c_{whlr} and of the angle of attack α on the horizontal stabilizer unit 8. Subsequently, as explained above, the velocity ν may be determined on the basis of the drag F_{whlr} and of the drag coefficient c_{whlr} or on the basis of the lift Fₐₕₗᵣ and of the lift coefficient cₐₕₗᵣ.

Alternatively, if an angle of attack α is known, from a corresponding wing polar curve or tail-unit polar curve a value relating to cₐₕₗᵣ or relating to c_{whlr} of the corresponding flow body may be read out. In this context it should be noted that the angle of attack of the horizontal stabilizer unit may differ by a setting angle from the angle of attack of the wing.

Of course, the above statements also apply to determining the velocity based on the aerodynamic forces on the wings 4 of the aircraft 2.

To provide a better understanding, FIG. 3 shows a polar diagram with a polar curve 18 that shows the ratio of a lift coefficient cₐ to a drag coefficient c_{w} of an arbitrary flow body. The polar curve 18 shown represents, for example, a wing. An optimal glide ratio with the best possible ratio of lift to drag results from applying a beam 20 from the origin of the diagram to the positive gradient of the polar curve 18 so that the beam 20 coincides with the tangent of the polar curve 18. The distance between the origin and a point on the polar curve 18 further corresponds to the quotient of lift coefficient cₐ and drag coefficient c_{w}. By finding a point 22 at a distance from the origin, which distance is determined by k, for measuring the force at that moment both flow coefficients can be determined Determining the coefficients may take place by reading out or interpolating the desired coefficients from a multi-dimensional data record on which the polar curve is based.

The method according to the present disclosure thus makes it possible to achieve reliable and robust determination of the flight velocity of an aircraft completely independently of environmental conditions, thus making it possible to support measured values obtained with the use of classical methods relating to the flight velocity in order to improve redundancy and reliability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for determining a flight velocity of an aircraft including a flow body, the method comprising the steps of:
acquiring a change in a length of a structural component connected to the flow body;
determining at least one aerodynamic force acting on the flow body based on the measured change in the length of the structural component connected to the flow body;
determining a flow coefficient of the flow body; and
calculating an incident flow velocity on the flow body, taking into account the determined flow coefficient and the determined aerodynamic force.

2. The method of claim 1,
wherein the at least one aerodynamic force comprises the drag of the flow body.

3. The method of claim 1,
wherein the at least one aerodynamic force comprises the lift of the flow body.

4. The method of claim 1,
wherein determining the flow coefficient comprises reading out the flow coefficient based on a measured or set angle of attack from a data record.

5. The method of claim 3,
wherein determining the flow coefficient comprises determining a quotient from the lift and a drag of the flow body, and determining the flow coefficient from a polar curve of the flow body.

6. The method of claim 1,
wherein determining the at least one aerodynamic force acting on the flow body comprises calculating at least one force that causes the change in the length of the structural component taking into account material characteristic of the structural component;

7. The method of claim 6,
wherein acquiring the change in the length takes place by means of at least one strain gauge.

8. A device for determining a flight velocity of an aircraft including a flow body, the device comprising:
a device for acquiring a change in a length of a structural component connected to the flow body; and
a calculation unit that is configured to:
determine at least one aerodynamic force acting on the flow body based on the acquired change in the length of the structural component;
determine a flow coefficient of the flow body; and
calculate an incident flow velocity on the flow body based on the flow coefficient and on the at least one aerodynamic force.

9. The device of claim 8, further comprising at least one strain gauge for acquiring the change in the length of the structural component.

10. The device of claim 8, further comprising a storage device that is connectable to the calculation unit, which storage device is configured to provide to the calculation unit at least one of aerodynamic and mechanical parameters for determining the flight velocity.

11. An aircraft with at least one flow body, comprising:
a structural component coupled to the at least one flow body;
a device for determining a flight velocity of the aircraft, the device including a second device for acquiring a change in a length of the structural component; and
a calculation unit that:
determines at least one aerodynamic force acting on the at least one flow body based on the acquired change in the length of the structural component;
determines a flow coefficient of the flow body; and
calculates an incident flow velocity on the flow body based on the flow coefficient and on the at least one aerodynamic force.

12. The aircraft of claim 11,
wherein the at least one flow body is a vertical stabilizer

13. The aircraft of claim 11,
wherein the at least one flow body is a wing.

14. The aircraft of claim 11,
wherein the at least one flow body is a horizontal stabilizer unit.

15. The method of claim 6, wherein calculating the at least one force further comprises:
determining the at least one force as an effective force component in a predetermined direction of the aircraft.

16. The method of claim 6,
wherein acquiring the change in the length of the structural component takes place with an optical device.

17. The method of claim 16,
wherein the optical device comprises fiber Bragg gratings.

18. The device of claim 8, further comprising at least one optical device for acquiring the change in the length of the structural component.

19. The aircraft of claim 11, further comprising at least one strain gauge for acquiring the change in the length of the structural component.

20. The aircraft of claim 11, further comprising a storage device that is connectable to the calculation unit, which storage device provides the calculation unit at least one of aerodynamic and mechanical parameters for determining the flight velocity.
